(19) United States
(12) Patent Application Publication
(10) Pub. No.: US 2018/0150828 A2
(43) Pub. Date: May 31, 2018

(54) Server for Managing Card Transaction Service, Card Transaction Service Management Method, and Card Transaction Service Management System

(71) Applicant: KONA I CO., LTD., Seoul (KR)

(72) Inventors: Minaoar Hossain Tanzil, Dhaka (BD); Sang Hoon Han, Gyeonggi-do (KR); Bong Soo Ryu, Gyeonggi-do (KR)

(21) Appl. No.: 15/609,833

(22) Filed: May 31, 2017

(51) Int. Cl. G06Q 20/34

(52) U.S. Cl. CPC G06Q 20/346

(57) ABSTRACT

Disclosed are a server for managing a card transaction service, a card transaction service management method, and a card transaction service management system. The server includes a transaction management unit that receives a request message for setting a physical card from a mobile terminal and transmits the request message to a token service provider, the token service provider that receives the request message to extract a token value of a mobile card and maps PAN information corresponding to the token value of the mobile card to a token value of the physical card to store the mapped PAN information, and a card management unit that stores at least one PAN information and transaction detail information corresponding to the at least one PAN information. The request message includes the token value of the physical card and information on the mobile card mapped to the physical card.

### CROSS-REFERENCE TO RELATED APPLICATION

This application claims priority under 35 U.S.C. § 119 to Korean Patent Application No. 10-2016-0091787, filed Jul. 20, 2016, which is herein incorporated by reference in its entirety.

### BACKGROUND

The present disclosure relates to a server for managing a card transaction service, a card transaction service management method, and a card transaction service management system, and more particularly, relates to a card transaction service management server, a card transaction service management method, and a card transaction service management system for utilizing a mobile host card emulation (mobile HCE) issued in token form in conjunction with a physical card.

Magnetic stripe cards, which have commonly used in credit cards, debit cards, or prepaid cards, are seriously exposed to counterfeiting, forging, etc., and as a means to solve the problem, smart card-based EMV (a technical standard for IC cards created by Europay, MasterCard, and VISA) cards are developed. In recent, the merchant terminals that only read the magnetic stripe are replaced with IC card terminals, and thus the IC cards are becoming increasingly used.

Meanwhile, with the spread of smartphones, a pin technology, which allows card holders to pay online/offline using a mobile card stored in the smartphone without using a plastic card, has been developed rapidly.

However, mobile payment is available only when the card holders carry the smartphone and the smartphone is powered on. In cases when the smartphone is powered off, the smartphone is lost, the merchant does not have a terminal for mobile payment (e.g., a barcode reader or an NFC terminal), etc., the smartphone is not able to be used as a means of payment. In addition, users accustomed to using the smartphone have no difficulties in running a mobile application to perform payment using the smartphone, but users who are not accustomed to using the smartphone do not use the smartphone as the mobile terminal for payment.

In order to solve the problem, a card-shaped terminal capable of emulating magnetic stripe cards or transmitting data using near-field communication is disclosed in “system and method for mobile payment service using card-shaped terminal” (Korean Published Patent Application No. 10-2016-0043473). Since the card-shaped terminal is used rather than the mobile terminal with the disclosed technology, it has the advantage of being able to use the existing infrastructure such as the merchant terminal. However, it is not feasible to commercialize the disclosed technology mainly because the effect of replacing the existing card is not big enough in terms of economy and efficiency, and it is difficult to apply the technology to the users who prefer the mobile payment.

### BRIEF SUMMARY

Aspects of the present disclosure are to address at least the above-mentioned problems and/or disadvantages and to provide at least the advantages described below. Accordingly, an aspect of the present disclosure is to provide a card transaction service management server, a card transaction service management method, and a card transaction service management system for utilizing a mobile card in conjunction with a physical card to solve problems with a mobile card payment and a card payment.

According to the present disclosure, a server for managing a card transaction service includes a transaction management unit that receives a request message for setting a physical card from a mobile terminal and transmits the request message to a token service provider, the token service provider that receives the request message to extract a token value of a mobile card and maps PAN information corresponding to the token value of the mobile card to a token value of the physical card to store the mapped PAN information, and a card management unit that stores at least one PAN information and transaction detail information corresponding to the at least one PAN information. The request message includes the token value of the physical card and information on the mobile card mapped to the physical card.

According to the present disclosure, a method for managing a card transaction service performed by a service server includes receiving a request message for setting a physical card from a mobile terminal, extracting, by a token service provider, a token value of a mobile card by receiving the request message, mapping PAN information corresponding to the token value of the mobile card to a token value of the physical card to store the mapped PAN information, and generating and storing, by a card management unit, the PAN information and transaction detail information corresponding to at least one of the PAN information. The request message includes the token value of the physical card and information on the mobile card mapped to the physical card.

According to the present disclosure, a system for managing a card transaction service includes a mobile terminal that stores at least one mobile card using a service application and transmits a setting request message to map the physical card to the mobile card, and a service server that receives the request message from the mobile terminal and maps PAN information corresponding to a token value of the mobile card to a token value of the physical card to store the mapped PAN information. The request message includes the token value of the physical card and information on the mobile card mapped to the physical card.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a schematic view showing a management system according to an embodiment of the present disclosure;

FIG. 2 is a block diagram showing an issuance procedure of a management system according to an embodiment of the present disclosure;

FIG. 3 is a block diagram showing a payment procedure of a management system according to an embodiment of the present disclosure;

FIG. 4 is a view illustrating a token storing method of a management system according to an embodiment of the present disclosure;

FIG. 5 is a view illustrating a token mapping method of a management system according to an embodiment of the present disclosure;

FIG. 6 is a flowchart illustrating a physical card registration method according to an embodiment of the present disclosure;

FIG. 7 is a flowchart illustrating a transaction method according to an embodiment of the present disclosure; and

FIG. 8 is a view showing embodiments for inputting information on a physical card via a mobile terminal.

Throughout the drawings, it should be noted that like reference numbers are used to depict the same or similar elements, features, and structures.

### DETAILED DESCRIPTION

In the present disclosure, as a specific structural or functional description given to embodiments in accordance with concepts of the present invention will be illustrated for the purpose of describing only embodiments according to the concepts of the present invention, the embodiments according to the concepts of the present invention may be embodied in various forms, but should not be limited the embodiments described herein.

Since the embodiments according to the concepts of the present invention may be embodied in many different forms, these embodiments will be described in detail with reference to accompanying drawings. However, these embodiments according to the concepts of the present invention should not be construed as being limited to the embodiments set forth herein. Accordingly, those of ordinary skill in the art will recognize that modification, equivalent, and/or alternative on the various embodiments described herein can be variously made without departing from the scope and spirit of the present disclosure.

The terms, such as “first”, “second”, and the like used herein may refer to various elements of various embodiments of the present invention, but do not limit the elements. Such terms may be used to distinguish one element from another element. For example, without departing the scope in accordance with the concepts of the present invention, a first element may be referred to as a second element, and similarly, a second element may be referred to as a first element.

It will be understood that when an element is referred to as being “(operatively or communicatively) coupled with/to” or “connected to” another element, it can be directly coupled with/to or connected to the other element or an intervening element may be present. In contrast, when an element is referred to as being “directly coupled with/to” or “directly connected to” another element, it should be understood that there are no intervening element. Similarly, words such as “between”, “directly between”, “adjacent to”, “directly adjacent to”, and the like should be interpreted in a like fashion.

Terms used in this specification are used to describe embodiments of the present disclosure and are not intended to limit the scope of the present disclosure. The terms of a singular form may include plural forms unless otherwise specified. The term “include,” “comprise,” “including,” or “comprising” used herein indicates disclosed functions, operations, or existence of elements but does not exclude other functions, operations or elements. It should be further understood that the term “include”, “comprise”, “have”, “including”, “comprising”, or “having” used herein specifies the presence of stated features, integers, operations, elements, components, or combinations thereof but does not preclude the presence or addition of one or more other features, integers, operations, elements, components, or combinations thereof.

Unless otherwise defined herein, all the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal sense unless expressly so defined herein in various embodiments of the present disclosure.

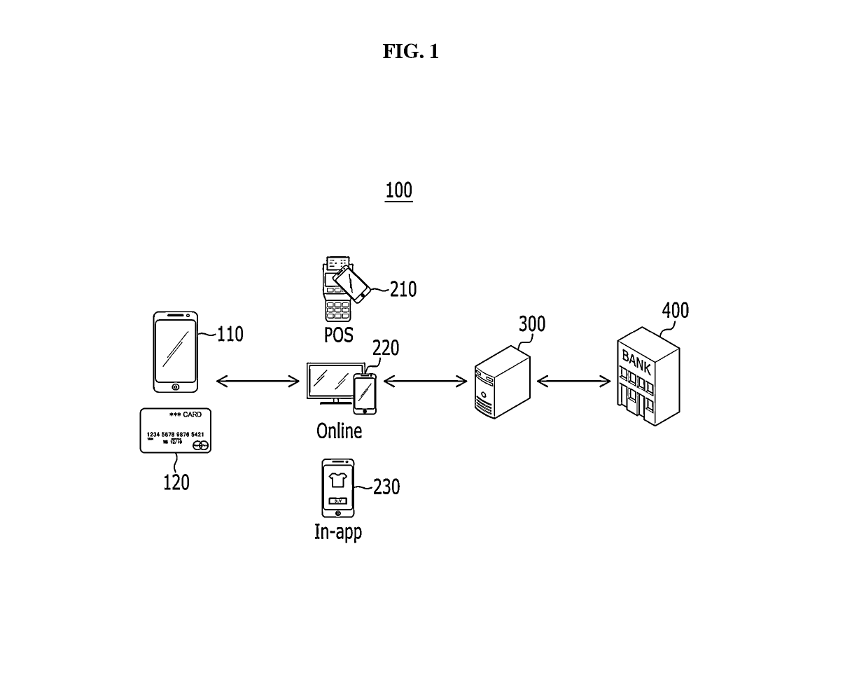

FIG. 1 is a schematic view showing a management system 100 for a card transaction service according to an embodiment of the present disclosure. The management system 100 may include a mobile terminal 110 and a physical card 120, which are used by a user, payment terminals 210, 220, and 230 used by a merchant for online and offline payments, a service server 300, and a financial institution 400.

Each of the mobile terminal 110, the physical card 120, and the payment terminals 210 to 230 according to the present disclosure may be an electronic device with a communication function. For instance, the electronic device may include at least one of a smartphone, a tablet personal computer (PC), a mobile phone, a video telephone, an e-book reader, a desktop PC, a laptop PC, a netbook computer, a personal digital assistant (PDA), a portable multimedia player (PMP), an MP3 player, a mobile medical device, a camera, a wearable device (e.g., a head-mounted-device (HMD), such as electronic glasses, an electronic apparel, an electronic bracelet, an electronic necklace, an electronic appcessory, an electronic tattoo, a smart watch, and the like).

As another embodiment, the electronic device may be a smart home appliance. The smart home appliance may include at least one of, for example, a television (TV), a digital versatile disc (DVD) player, an audio, a refrigerator, an air conditioner, a cleaner, an oven, a microwave oven, a washing machine, an air cleaner, a set-top box, TV boxes (e.g., Samsung HomeSync™, Apple TV™, or Google TV™), game consoles, an electronic dictionary, an electronic key, a camcorder, an electronic picture frame, and the like. In addition, the electronic device may include at least one of medical devices (e.g., a magnetic resonance angiography (MRA), a magnetic resonance imaging (MRI), a computed tomography (CT), a scanner, an ultrasonic device, etc.), a navigation device, a global positioning system (GPS) receiver, an event data recorder (EDR), a flight data recorder (FDR), a vehicle infotainment device, marine electronics (e.g., a navigation equipment for marine vessels, a gyrocompass, etc.), avionics, security devices, head units for vehicles, industrial or home robots, automatic teller's machines (ATMs) of financial institutions, and points of sales (POSs) of merchants. As another example, the electronic device may include at least a portion of furniture or buildings/structures, electronic boards, electronic signature receiving devices, projectors, or various measuring instruments (e.g., water meters, electricity meters, gas meters, or wave meters, and the like) with the communication function. The electronic device according to the present disclosure may be one or more combinations of the above-mentioned devices. In addition, an electronic device according to the present disclosure may be a flexible electronic device. Also, electronic devices according to various embodiments of the present disclosure are not limited to the above-mentioned devices.

Referring to FIG. 1, the mobile terminal 110 and the physical card 120, which are used by the user, indicate electronic devices with online and offline payment functions. For instance, the mobile terminal 110 may include a mobile phone, a smartphone, a notebook computer, a digital broadcasting terminal, a personal digital assistant, a portable multimedia player, a navigation unit, a tablet PC, and the like, but it should not be limited thereto or thereby. That is, the mobile terminal 110 may be various devices having a communication function capable of performing a contactless payment via a short-range wireless communication, such as a near field communication (NFC), and a separate payment-enabled application.

The physical card 120 may be implemented in the form of an actual (tangible) physical card, e.g., a quadrangular-shaped plastic card, which is equipped with the communication function capable of communicating with the mobile terminal 110 and a payment module for performing a payment. As an embodiment, the physical card 120 may be implemented in various forms, such as a magnetic stripe card, an IC card, a combination card, etc.

The mobile terminal 110 or the physical card 120 may provide not only the payment with the NFC but also the payment with the IC chip or the magnetic stripe and may include various contact and contactless payment functions.

The payment terminals 210 to 230 provided by the merchant may be implemented in various forms as shown in FIG. 1. An offline store may include the payment terminal 210 that reads out card information from a medium, for example, the mobile terminal 110 or the physical card 120, owned by the user. The payment terminal 210, such as the POS, may receive the card information from the mobile terminal 110 or the physical card 120 of the user by using a wireless communication technology, such as the NFC, a bluetooth (BT), a bluetooth low energy (BLE), etc.

An online store may provide a payment system through a PC 220 of the user or a mobile application 230 and perform the payment transaction using the card information provided to a merchant server managing the online store from the user.

The service server 300 may include an HCE (Host Card Emulation)-based service server and may be implemented to store and manage personal information including the card information in a business server that performs a function of a cloud SE (Secure Element) (or a cloud platform) without storing the personal information including the card information in a hardware SE, such as a universal integrated circuit card (UICC), an embedded SE, and the like. A cloud SE system may indicate a card information storage system that stores a mobile card, which is issued by a request of the user of the mobile terminal from an external source (e.g., a card issue unit of the service server 300), in an SE that is a safe storage, and the cloud SE system may periodically update the latest information of the mobile card. Various embodiments of the present disclosure may employ a tokenization technology to solve a security problem when implementing the HCE technology and may issue a token corresponding to the card information to prevent the card information or the personal information from being exposed.

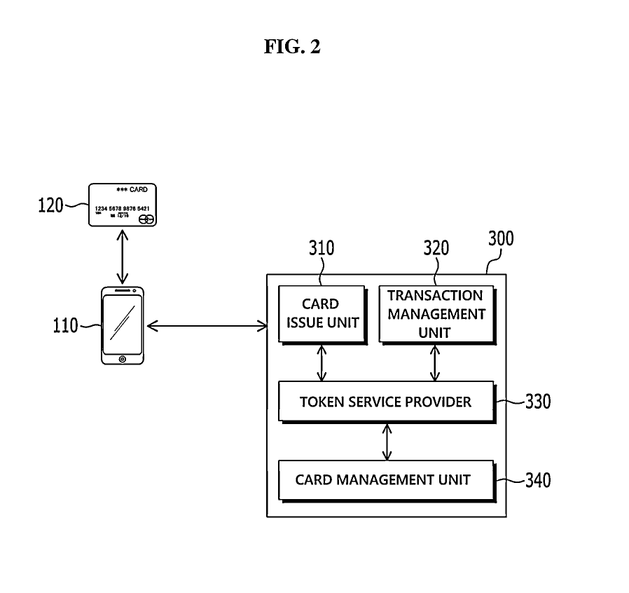

As an embodiment, a TSP server (e.g., a token service provider 330 shown in FIG. 2) may issue a token value corresponding to primary account number (PAN) information (card information) in response to a card issuance request from the mobile terminal 110. The TSP server may map the issued token value to the PAN information and store the mapping result in the form of a table. As another embodiment, the TSP server may be implemented to store a predetermined algorithm that may infer a value between the token value and the PAN information or to store only a path to a mapping table of the token value and the PAN information.

The service server 300 of the present disclosure may further include a ledger management server (e.g., a card management unit 340 shown in FIG. 2) that manages a reloaded amount or a balance. The ledger management server may manage the reloaded amount and the balance after the transaction corresponding to the PAN information or an account registered when the mobile terminal 110 is registered to the service server 300. For instance, when the ledger management server receives a transaction request from the merchant payment terminals 210 to 230, the ledger management server may check the balance corresponding to the PAN information included in the transaction request and approve the payment in a case that a payment amount is within a range of the balance. In this case, the transaction request may include the token value, and the ledger management server may obtain the PAN information associated with a corresponding token value to perform a payment approval process.

The management system 100 may further include the financial institution 400. As an embodiment, in case of services (e.g., a credit card authorization or an account transfer) that require approval or read by the financial institution 400, the service server 300 may be implemented to be approved of the transaction via a server of the financial institution 400 during the transaction. The financial institution 400 may include various financial-related institutions, such as banks, card issuers, securities companies, partnership companies, etc.

The management system 100 of the present disclosure may provide a method of transaction in which two or more media, e.g., the mobile terminal 110 and the physical card 120, in conjunction with each other to be used as one card for the convenience of the user while using an existing management system infrastructure. In the embodiment of the present disclosure, only the physical card 120 has been shown as a representative example, but it should not be limited thereto or thereby. That is, the transaction method may be applied to various smart devices, wearable devices, and IoT (Internet of Things) devices.

As an embodiment, the card may be issued to the mobile terminal 110 through the service server 300. In this case, the mobile terminal 110 may install and use a separate application or may use a web page provided by the service server 300 to manage the card and the transaction. The service server 300 may store the card information on the issued card in a cloud system of the service server 300. The card information may be generated in the form of a token value and issued to the mobile terminal 110 in the form of an HCE card. The HCE card may be a card that performs the card emulation by using the HCE function of the mobile terminal 110 without a physical SE and may be stored in the form of the token value. The user may transmit the token value to the merchant payment terminals 210 to 230 to perform the transaction through the service server 300 when transacting using the mobile terminal 110.

Meanwhile, the user may perform the online or offline payment using the physical card 120 in embodiments of the present disclosure. For instance, the physical card 120 may be implemented in the form of a smart card that is an electronic card equipped with an integrated circuit (IC) memory device to store massive information, may include one or more ICs embedded therein, and may be various cards used in a financial institution, a medical insurance card, a transportation card, a credit card, etc.

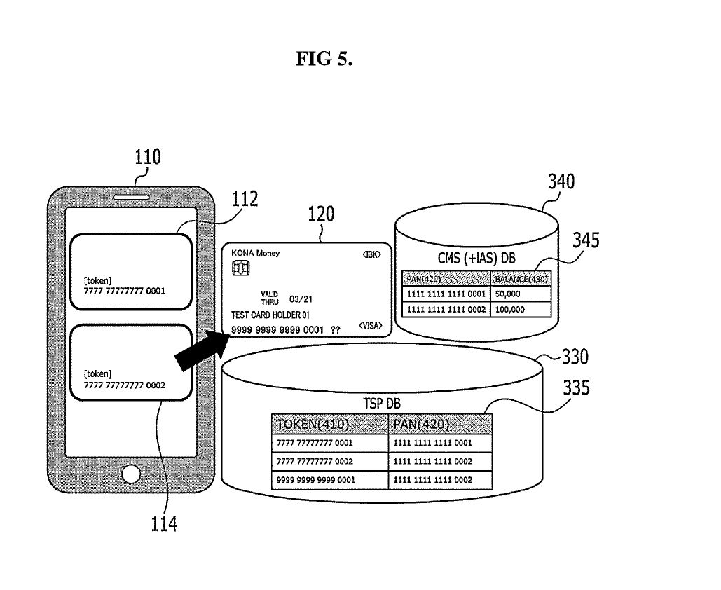

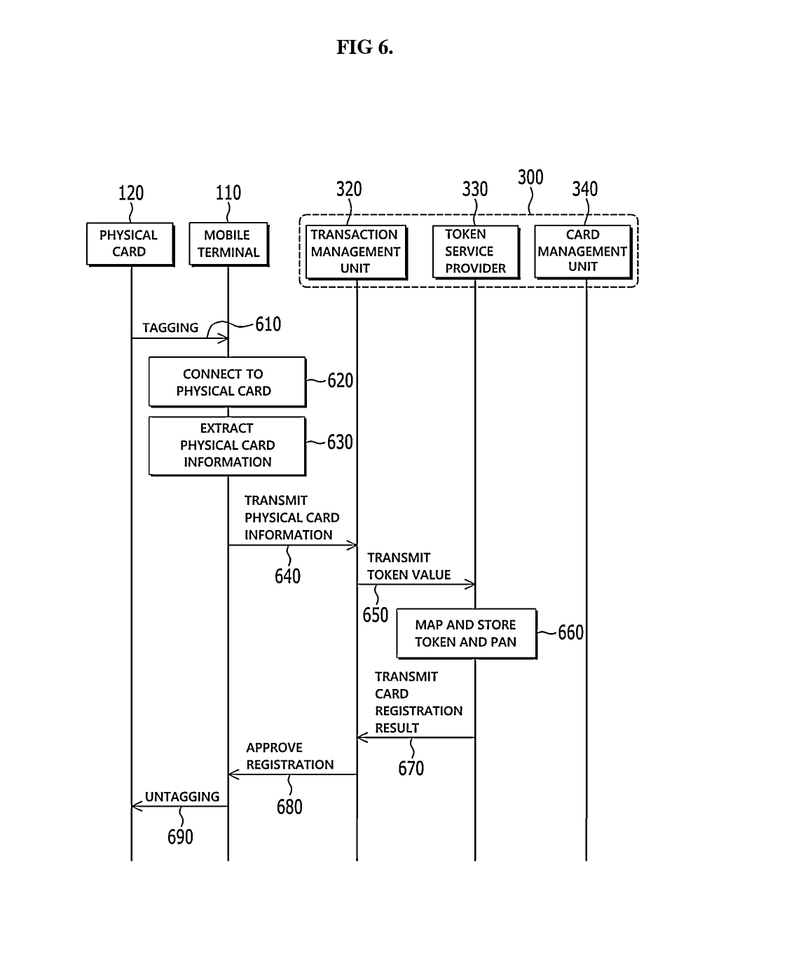

The physical card 120 of the present disclosure may be implemented to be used in conjunction with at least one HCE card issued to the mobile terminal 110. Similar to the HCE card, the physical card 120 may have a unique token value when being issued. The physical card 120 may be set to operate as one of cards stored in the mobile terminal 110 after or during being connected (tagged) to the mobile terminal 110. For instance, in a case that the user sets the physical card 120 to an “A” card among “A” and “B” cards stored in the mobile terminal, the physical card 120 may be operated in the same manner as the “A” card during the transaction. In this case, an interlinking method between the physical card 120 and the HCE card of the mobile terminal 110 will be described in detail with reference to FIGS. 5 and 6.

As described above, the present disclosure may provide the management system and method for interlinking the card issued to the mobile terminal and the physical card. According to the management system, the user may load several cards issued to the mobile terminal into the physical card and use them. The mobile terminal has an advantage of easy card issuance, and the physical card has an advantage of increased card-usage rate by users who are familiar with the physical card increases since the physical card may be used in the same manner as a conventional card. In addition, according to the present disclosure, since the user may use multiple mobile cards with one physical card, the user does not need multiple cards to be issued, and the card issuer may reduce the cost of issuing the cards.

FIG. 2 is a block diagram showing the card issuance procedure of the service server 300 according to an embodiment of the present disclosure. The service server 300 may issue the mobile card through the mobile terminal 100.

The mobile terminal 110 is an electronic device that may issue the mobile card and perform the payment of the mobile card. Mobile payment applications, which are executed by a processor (not shown) of the mobile terminal 110, may be installed in the mobile terminal 110, and a secure element (SE) may be embodied in the mobile terminal 110. The SE may be implemented by the UICC, the embedded SE, a secure digital (SD) card, and the like, but does not exclude other types of SE. The SE may include mobile payment applets issued by the service server 300. The mobile payment applets may be distinguished from each other for each issued mobile card as a means of mobile payment. As an embodiment, each of the mobile payment applets according to the management system of the present disclosure may include a token value corresponding to the card information. In addition, the SE may include a wallet management applet (WMA) for managing the mobile payment applications called a mobile wallet.

Meanwhile, the service server 300 may include a card issue unit 310, a transaction management unit 320, a token service provider 330, and a card management unit 340. The elements 310 to 340 of the service server 300 have been shown in FIG. 2 as separate elements, but the elements may be implemented in a combination of two or more elements. In addition, the service server 300 may further include elements required to implement the transaction method of the present disclosure in addition to the elements shown in FIG. 2. Further, the elements 310 to 340 may be implemented to communicate with each other.

The card issue unit 310 may issue the card in response to the card issuance request from the mobile terminal 110. In the case that the card issue unit 310 receives the card issuance request via the application installed in the mobile terminal 110 or the separate web page, the card issue unit 310 may issue the card when a predetermined condition, for example, a credit condition, is satisfied. For instance, the card issue unit 310 may request the token service provider 330 to generate the token value. The card issue unit 310 may receive the token value, which corresponds to the card issued, from the token service provider 330 and transmit the token value to the mobile terminal 110.

As another embodiment, for the issuance of the physical card 120, a card issue system other than the service server 300 may be used to issue the physical card. The card issue system may record the token value and/or an amount, for example, a fixed amount, in the physical card to issue a new card. When the physical card is issued, the token value and the card information may be stored in the service server 300 or separately stored for management. The card issue system, which is a different server from a TSM server, may include a server used to physically issue the physical card.

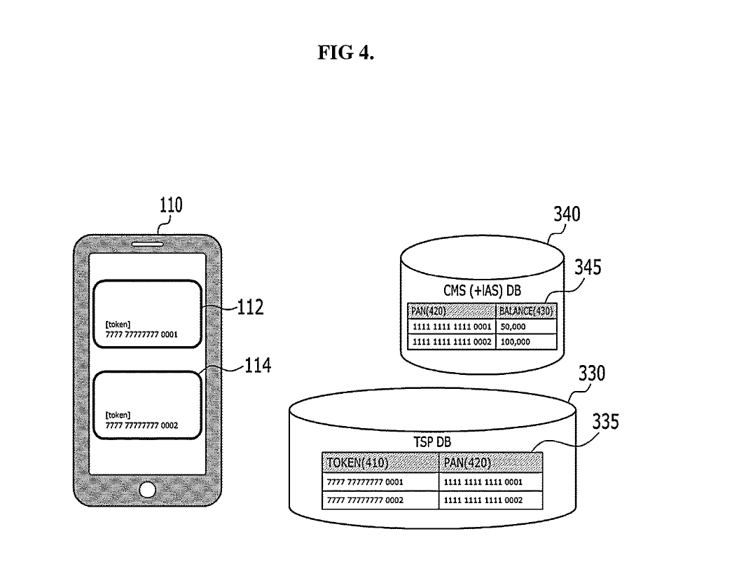

In the embodiment of the present disclosure, since mobile cards 112 and 114 (refer to FIGS. 4 and 5) and the physical card 120 are used in conjunction with each other, the token value of the physical card may be managed after being mapped to the mobile card without using the TSM server that separately manages the SE of the physical card.

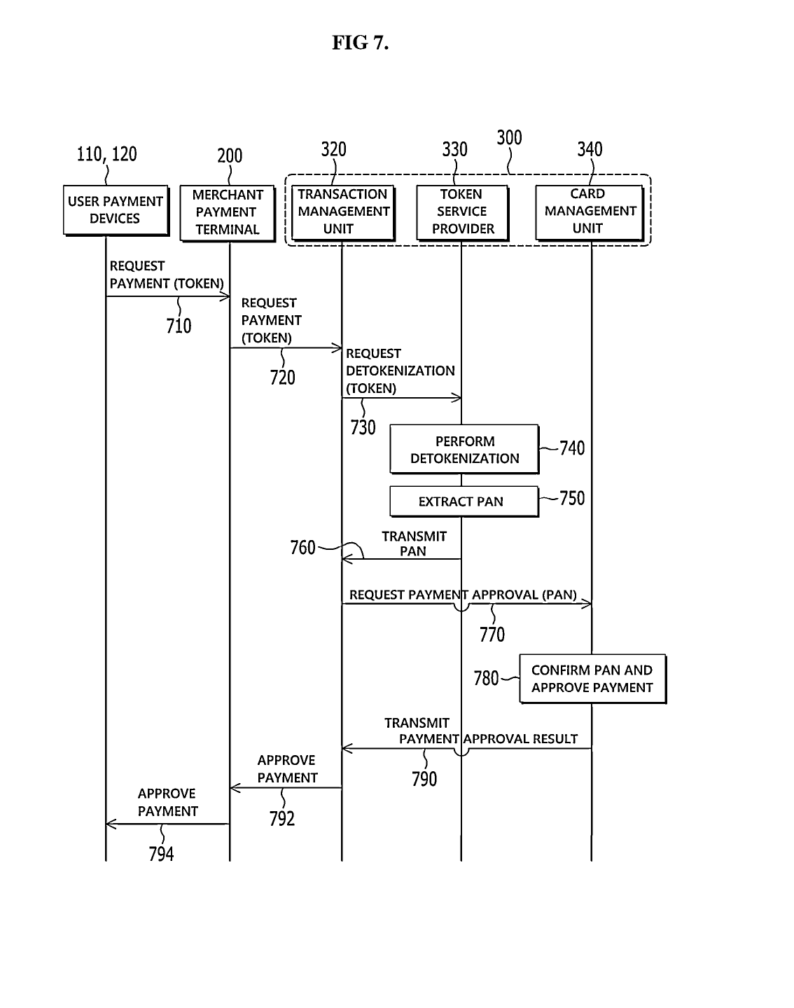

The transaction management unit 320 may serve as an element for processing the transaction request after the card is issued. The transaction management unit 320 may receive the transaction request message through a service application of the mobile terminal 110 or the transaction request message from the payment terminals 210 to 230 and transmit the transaction request message to the management system. The payment process will be described in detail with reference to FIG. 7.

The token service provider 330 may serve as an element for converting the card information to the token value and storing the token value and may be implemented in the form of a server. As an embodiment, the token service provider 330 may map the token value generated with respect to the card information and store the mapped token value in the form of a table. In addition, the token service provider 330 may separately store an algorithm for generating the token value or a path for searching for the token value in the table. The token service provider 330 may be implemented to perform the card issuance by itself or to generate the token value, which is required to issue the card, in conjunction with another management server.

The card management unit 340 may be a server that manages the balance (or the reloaded amount) with respect to the card information of the corresponding card as the ledger management server described above. When the card is issued, the card management unit 340 may generate new card information on the issued card and store initial balance information. For instance, an initial balance of the mobile card may be zero (0), but the balance of the mobile card may be a certain amount through reloading. In a case where the physical card is a fixed amount card, a corresponding flat rate may be recorded in the physical card as the balance, and in a case where the physical card is a reloadable card, the balance may be recorded as zero.

One or more mobile cards may be issued to the mobile terminal 110 through a communication with the service server 300. The service server 300 may issue a card by itself or issue a new card or a mobile card of an existing card in conjunction with the financial institution 400. The mobile terminal 110 may be selectively used as the issued cards.

As described above, the card issuance by the mobile terminal 110 may be done quickly and conveniently since the card issuance does not need to be conducted through the financial institution 400. In addition, in a case that an authentication procedure is needed during the card issuance process, the authentication procedure may be performed using an authentication certificate or biometric information stored in the mobile terminal.

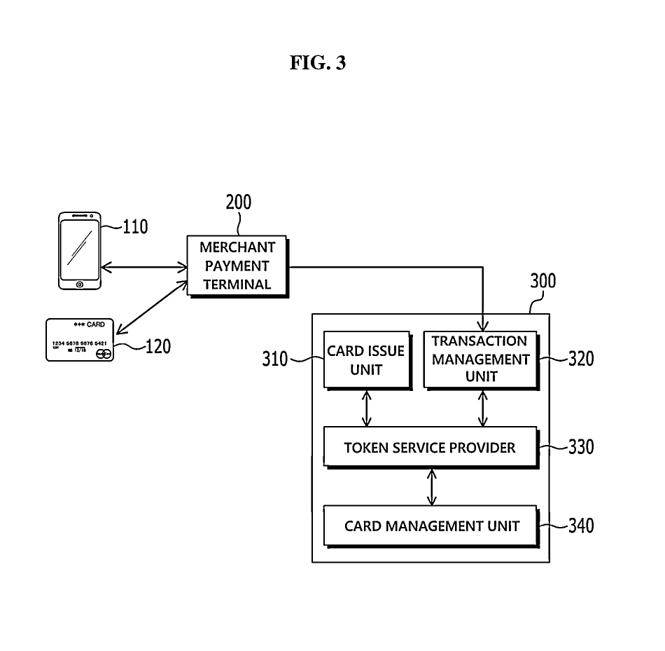

FIG. 3 is a block diagram showing the payment procedure of the management system according to an embodiment of the present disclosure. The user may perform the payment using the mobile card stored in the mobile terminal 110 or the physical card 120.

As described above, in the case that the user requests the payment, the merchant payment terminal 200 may receive the payment request and transmit the payment request to the service server 300. The payment request may include the token value of the card used to pay. For instance, the payment request may include the token value and transaction information, such as date and time of transaction, amount of transaction, etc. In addition, the payment request may further include cryptogram information for authenticating a validity of the payment request. The payment request message may follow a format specified by international standards for compatibility.

The transaction management unit 320 of the service server 300 may receive the payment request to extract the PAN information (the card information) mapped to the token value through the token service provider 330. The card management unit 340 may receive the card information extracted from the token value by the token service provider 330 to inquire the balance with respect to corresponding card information. The card management unit 340 may determine whether the amount requested for the payment is within the range of the balance and may process the payment approval when the amount requested for the payment is within the range of the balance.

When the payment is performed using the physical card 120, the service server 300 may extract the PAN information stored in the token value of the physical card 120 to process the payment. In this case, the token value of the physical card 120 may be previously mapped to and stored in a specific PAN. In addition, the PAN value may be a PAN value corresponding to one card set by the user among the HCE cards of the mobile terminal 110. That is, in accordance with the user's setting before the payment, one of the HCE cards may be set to be mapped to one physical card 120, and the physical card may be used in the same way as the HCE card that is set by the user. The mapping method will be described in detail with reference to FIGS. 5 and 6.

According to the present disclosure, one card information may be used in conjunction with various media, and thus usability of the card information may become high. In addition, since the embodiments of the present disclosure may use existing infrastructure, there are less difficulties in introducing new technologies.

FIG. 4 is a view illustrating a token storing method of a management system according to an embodiment of the present disclosure. As shown in FIG. 4, one or more mobile cards may be issued to the mobile terminal 110. In this case, the mobile card may be stored in the form of a token according to an HCE technology.

As an embodiment, a first card 112 and a second card 114 may be issued to the mobile terminal 110 according to the user request. The first card 112 may have a token value of 7777 77777777 0001, and the second card 114 may have a token value of 7777 77777777 0002. As shown in FIG. 4, the token value may consist of a sixteen-digit number. That is, the token value may be designed according to an existing card-numbering system. In addition, each digit of the token value may be a significant number. For instance, the first four digits may be configured to include values used to identify the card issuer. In the present embodiment, the token value may be implemented as numbers similar to an existing card, but it should not be limited thereto or thereby.

The first card 112 and the second card 114 may be issued to and stored in the service server 300. In FIG. 4, a TSP DB 330 may indicate a DB (storage) of the token service provider 330 of the management system, and a CMS (Card Management System) DB 340 may indicate a DB included in the card management unit 340 of the management system.

The TSP DB 330 may map a token value 410 and a PAN value 420 corresponding to card information and store the mapped token value 410 and the mapped PAN value 420 in the table form 335. For instance, the TSP DB 330 may map and store the PAN value (1111 1111 1111 0001) corresponding to the token value (7777 77777777 0001) of the first card 112 and may map and store the PAN value (1111 1111 1111 0002) corresponding to the token value (7777 77777777 0002) of the second card 114. In the present embodiment, the token value 410 and the PAN value 420 may be mapped in a one-to-one correspondence and stored in the table form, but they should not be limited thereto or thereby. That is, the TSP DB 330 may form the DB in various forms that enables to extract the PAN value 420 through the token value. As an example, the TSP DB 330 may define and store an algorithm capable of extracting the PAN value 420 or may map and store a path for searching for the PAN value.

The CMS DB 340 may manage amount of money (e.g., balances) respectively corresponding to the card information. In detail, the CMS DB 340 may manage the ledger corresponding to the PAN value 420 that is the card information. The ledger may indicate a file for recording assets, capitals, variable amounts, and balances, etc., of a corresponding account. In the present disclosure, a prepaid card will be described as the card. The prepaid card may be implemented to include balance information and change the balance information by subtracting an amount used by the user from the amount of the prepaid card. Accordingly, the CMS DB 340 shown in FIG. 4 may map and store the balance information 430 with respect to each card information 420 (345). In the present disclosure, the balance of about 50,000 KRW is recorded in the first card 112, and the balance of about 100,000 KRW is recorded in the second card 114. The card management unit 340 may inquire the balance information of the corresponding account when receiving the transaction request from the user. The card management unit 340 may approve the payment request when the payment request amount is within the remaining balance on the card. As another embodiment, in the case that the payment request amount exceeds the remaining balance on the card, the card management unit 340 may be implemented to transmit information on reloading or available loan.

As another embodiment, the service server 300 may issue a card ID when issuing the card and may further include a card issue system (CIS) in which the card ID and the PAN value are stored. The card ID may be a unique ID for each card issued to the mobile terminal 110 and may be implemented in numeric or character form. As described below, when the physical card is registered, the service server 300 may be implemented to receive the card ID of the selected HCE card and the token value of the physical card and map the token value of the physical card to the PAN value corresponding to the card ID.

FIG. 5 is a view illustrating a token mapping method of a management system according to an embodiment of the present disclosure. The embodiments of the present disclosure may be implemented to use the mobile cards 112 and 114 stored in the mobile terminal 110 in conjunction with the physical card 120.

As described above, one or more mobile cards may be issued to the mobile terminal 110. In this case, the mobile card may be stored in the form of a token according to the HCE technology. The service server 300 may store the PAN information 335 that is the card information corresponding to the token value of the first card 112 and the second card 114. The TSP DB 330 may indicate the DB of the token service provider 330 of the management system, and the CMS (Card Management System) DB 340 may indicate the DB included in the card management unit 340 of the management system.

As described with reference to FIG. 4, the first card 112 and the second card 114 may be issued to the mobile terminal 110 in response to the user request. The first card 112 may have the token value of 7777 77777777 0001, and the second card 114 may have the token value of 7777 77777777 0002. The token value may consist of a sixteen-digit number similar to the existing card. However, according to embodiments, the token value may be implemented by various characters, numbers, or symbols.

When the card is issued, the TSP DB 330 may generate and store the token value corresponding to the PAN value of the issued card, and the CMS DB 340, which is a ledger server, may store ledger information corresponding to the PAN information. As an embodiment, in a case that a financial service is provided using the prepaid card, the CMS DB 340 may record the balance information corresponding to each card.

The user may use the physical card 120 and the mobile cards 112 and 114 in conjunction with each other by using the management system 100 provided by the present disclosure. In addition, the user may selectively load the multiple cards issued to the mobile terminal 110 into the physical card 120 to selectively use the multiple cards.

First, a method for registering the physical card 120 will be described in detail with reference to FIGS. 6 to 8. The user may load one of the HCE cards 112 and 114 issued to the mobile terminal 110 into the physical card 120 that may hold multiple card applets. The user may run a service application to implement a transmission function (for example, an “export function” or a “copy function” that exports or copies the first card 112 of the mobile terminal to the physical card) of the HCE card in the mobile terminal 110. The service application may be implemented by a software program provided by the management system or a basic software program installed in a terminal when the terminal is manufactured. The mobile terminal 110 may perform the transmission function of the HCE card and the physical card may be wirelessly connected by being tagged to the mobile terminal (steps 610 and 620). The term “tagging” used herein means that the mobile terminal and the physical card are connected with each other using the short-range wireless communication, such as the near field communication (NFC), the Bluetooth low energy (BLE), etc.

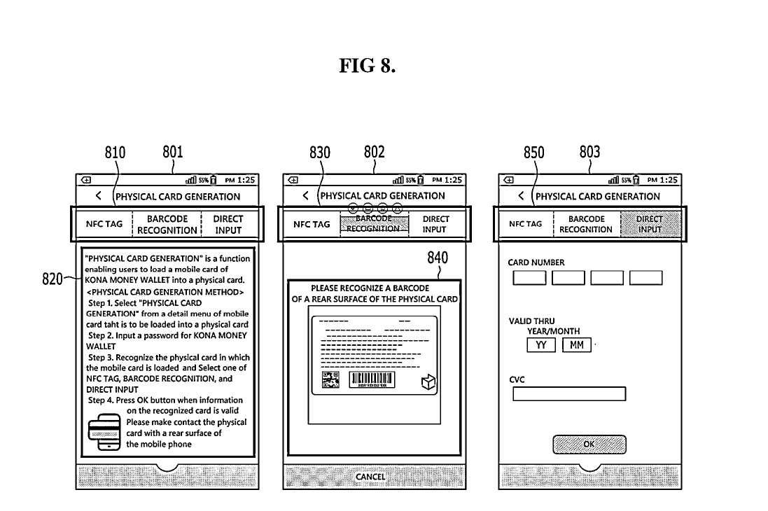

As shown in FIG. 8, the embodiments of the present disclosure may use a variety of methods 801 to 803 to receive the card information on the physical card. According to embodiments shown in FIG. 8, in a case that the user starts a menu item for generating a physical card through the service application, menu items of an “NFC tag”, a “barcode recognition”, and a “direct input” are displayed in a menu area 810. In a case that the “NFC tag” is used (801), the user is guided to make contact the physical card with the mobile card as shown in a screenshot of FIG. 8 (820). In a case that the “barcode recognition” is selected in the menu area 810 (830) to use the “barcode recognition”, the mobile terminal 110 is implemented to display a guide message and recognize the barcode by taking a photo of the card using a camera (840). In addition, a method (803) in which the user may select the “direct input” in the menu area 810 (850) and directly input a card number, an expiration date, a CVC number, and the like may be provided.

When the mobile terminal 110 is connected to the physical card 120, the mobile terminal 110 may receive the information on the physical card. In this case, the information on the physical card may include the token value, the expiration date, CVC (static CVC), and a service ID of the physical card 120 (step 630). In the embodiments of the present disclosure, the token value of the physical card 120 is 9999 9999 9999 0001. The mobile terminal 110 may receive the token value of the physical card 120. The mobile terminal 110 may select the card to load into the physical card 120 among the HCE cards 112 and 114, which have been issued in advance, using the service application. For instance, in a case that the second card 114 is a coffee card 114 available to use in a coffee shop, the physical card 120 may be used the same as the coffee card 114 by setting the physical card 120 to be in conjunction with the coffee card 114.

In the embodiment of the present disclosure, the mobile card is selected after the mobile terminal 110 is connected to the physical card 120, but they should not be limited thereto or thereby. That is, the information on the physical card may be input after the mobile card is selected.

The mobile terminal 110 may transmit a card registration request message that includes token information of the physical card 120 and the card ID of the HCE card that is to be in conjunction with the token information to the service server 300 (step 640). As an embodiment, the mobile terminal 110 may transmit physical card setting information to the service server 300 through the service application running in the mobile terminal 110. The physical card setting information may correspond to a request message for setting the physical card and include the token value of the physical card and the card ID (or another identification information) of the HCE card to be mapped to the physical card. Selectively, the physical card setting information may include various setting information, such as a period (time) for mapping a specific HCE or a reservation for mapping another card according to time slot.

The transaction management unit 320 may receive the physical card setting information from the mobile terminal 110 and transmit the physical card setting information to the token service provider 330 (step 650). The token service provider 330 may receive the token value of the physical card 120 and information regarding the second card 114 to be mapped, and the token service provider 330 may extract and store the PAN information of the second card 114 to be mapped while storing the token value of the physical card 120 (step 660). As shown in FIG. 5, the TSP DB 330 may be implemented to allow the physical card 120 to be used after being mapped to the second card 114 by storing the same PAN value as the second card 114 in the token value (9999 9999 9999 0001) of the physical card.

As another embodiment, the transaction management unit 320 may check the service ID from the request message for setting the physical card and extract the corresponding PAN value from the HCE card ID that is a unique ID of the second card 114. For instance, the service server 300 of the present disclosure may include a database that maps and stores the card ID and the PAN value and may store the card ID and the PAN value, which are generated when the card is issued. Then, a verification may be performed using the information included in the request message, and the physical card may be mapped to the HCE card when the verification is completed. The transaction management unit 320 may transmit the token value of the physical card and the extracted PAN value of the second card to the token service provider 330, and the token service provider 330 may receive the token value of the physical card and the extracted PAN value of the second card and map the token value of the physical card to corresponding PAN value to store the mapped result.

In the above-mentioned embodiment, a manner in which the PAN value of the second card 114 is copied to the token value of the physical card has been described. As another embodiment, the token service provider 330 may be implemented in a manner in which the token value of the physical card is added to the token value and the PAN value of the second card 114. In addition, two or more token values may be mapped to and stored in one PAN value.

The token service provider 330 may store the token value and transmit the registered result to the transaction management unit 320, and the transaction management unit 320 may transmit the registered result to the mobile terminal 110 (steps 670 and 680). The mobile terminal 110 may inform of an untagging operation (or a “disconnection operation”) through the service application (step 690), and the user may untag after checking the registration of the physical card.

As described above, in the case that multiple token values are mapped to and stored in the same PAN value, the user may use multiple media as one card. For instance, in a case that the user is issued with the HCE card as a transportation card through the mobile terminal 110, sets the physical card 120 to be mapped to the transportation card, and maps and stores the transportation card in another wearable device (e.g., a smart watch), the user may use the mobile terminal 110, the physical card 120, and the wearable device (not shown) as the same transportation card.

As described above, since the user may use multiple media with only one card, a convenience in payment options may be improved, and time and cost may be saved since the user does not need multiple cards to be issued. In addition, the physical card may be used in conjunction with one of the HCE cards, and thus there is an advantage that one card may be used for various purposes.

In addition, in case of a multi-card recently released, e.g., a smart card that may hold multiple cards therein, there is an inconvenience with using a separate switch for switching cards or there is an inconvenience of selecting smart cards whenever the card is used. However, according to the card mapping method of the present disclosure, the user does not need to tag the card whenever the user pays with the card, and the card may be switched or used to fit the user's lifestyle. Further, there is an advantage that several cards and several media may be mapped and used according to purpose.

FIG. 7 is a flowchart illustrating a transaction method according to an embodiment of the present disclosure. The user may perform the payment in the merchant by using a user payment device such as the mobile terminal 110 or the physical card 120.

When the user performs the payment through the merchant payment terminal 200 using the user payment devices 110 and 120, the user payment devices 110 and 120 may transmit the payment request message to the merchant payment terminal 200 (step 710). The payment request message may be defined depending on a standard. In addition, the payment request message may include the token value of the user payment devices 110 and 120 and transaction detail information, such as a transaction amount, a transaction date and time, etc. The merchant payment terminal 200 may receive the payment request message and transmit the payment request message to the service server 300 (step 720).

The transaction management unit 320 of the service server 300 may receive the payment request message, extract the token value, and transmit the token value to the token service provider 330 to request detokenization (step 730). The token service provider 330 may inquire the TSP DB to extract the PAN value (steps 740 and 750). As described with reference to FIG. 5, the TSP DB may store the mapping information of the token value and the PAN value in the table form, and as another embodiment, the token service provider 330 may be implemented to extract the PAN value through a previously-defined algorithm or to store the path reaching the PAN value.

When the token service provider 330 transmits the extracted PAN value to the transaction management unit 320 (step 760), the transaction management unit 320 may transmit a transaction approval request message including the PAN value to the card management unit 340 (step 770). The card management unit 340 may inquire to confirm the PAN value included in the transaction approval request message and inquire the ledger information (e.g., the balance information 345 of FIG. 5) corresponding to the PAN value (step 780). For instance, in the case of the prepaid card, the card management unit 340 may process a transaction approval when a transaction approval request amount is equal to or smaller than the balance and reject the transaction approval when the transaction approval request amount is greater than the balance.

As described above, the card management unit 340 that manages the ledger determines the approval of the transaction requested with reference to the PAN value. Accordingly, even though the payment request is received from the payment devices having different token values from each other, the payment devices are recognized as one card in processing the payment request since the payment approval may be processed according to the same PAN value. There is an advantage in using the service server 300 in that the management system may recognize the different payment devices as the same card without separate synchronization operation although the card is used through different payment devices from each other.

The card management unit 340 may transmit the transaction approval result to the transaction management unit 320 (step 790), and the transaction management unit 320 may transmit the transaction approval result to the merchant payment terminal 200 and the user (step 792 and 794). In the case that the user performs the payment through the mobile terminal 110, the service server 300 may transmit the transaction approval result through the service application of the user.

As another embodiment, in the case that the user performs the payment through the physical card 120, the transaction approval result may be transmitted to the mobile terminal 110. In the case that the above-mentioned function is performed, a function of a personal account book may be implemented since the payments may be managed by the mobile terminal 110 even though the payment is performed through multiple media.

While the inventive concept has been described with reference to embodiments, it will be apparent to those skilled in the art that various changes and modifications may be made without departing from the spirit and scope of the inventive concept. Therefore, it should be understood that the above embodiments are not limiting, but illustrative.

What is claimed is:

1. A server for managing a card transaction service, comprising:
a transaction management unit configured to receive a request message for setting a physical card from a mobile terminal and transmit the request message to a token service provider;
the token service provider configured to receive the request message to extract a token value of a mobile card and map PAN information corresponding to the token value of the mobile card to a token value of the physical card to store the mapped PAN information; and
a card management unit configured to store at least one PAN information and transaction detail information corresponding to the at least one PAN information, wherein the request message includes the token value of the physical card and information on the mobile card mapped to the physical card.

2. The server of claim 1, wherein the token service provider matches the token value with the PAN information in a one-to-one correspondence and stores the token value matched with the PAN information in the form of a table.

3. The server of claim 1, further comprising a card issue unit that issues at least one mobile card in response to a request from the mobile terminal, wherein, when a new card is issued, the card issue unit generates and stores a token value, a card ID, and PAN information of the new card.

4. The server of claim 3, wherein the mobile card is stored in a service application installed in the mobile terminal in a host card emulation (HCE).

5. The server of claim 1, wherein the transaction management unit receives a transaction request message from a payment terminal and transmits a token value included in the transaction request message to the token service provider, and the token value is a token value of a card used for a transaction.

6. The server of claim 5, wherein the token service provider extracts the PAN information corresponding to the token value and transmits the extracted PAN information to the transaction management unit, the transaction management unit transmits the PAN information to the card management unit, and the card management unit determines whether to approve the transaction using the transaction detail information corresponding to the PAN information.

7. A method for managing a card transaction service performed by a service server, comprising:
receiving a request message for setting a physical card from a mobile terminal;
extracting, by a token service provider, a token value of a mobile card by receiving the request message;
mapping PAN information corresponding to the token value of the mobile card to a token value of the physical card to store the mapped PAN information; and
generating and storing, by a card management unit, the PAN information and transaction detail information corresponding to at least one of the PAN information, wherein the request message comprises the token value of the physical card and information on the mobile card mapped to the physical card.

8. The method of claim 7, wherein the token service provider matches the token value with the PAN information in a one-to-one correspondence and stores the token value matched with the PAN information in the form of a table.

9. The method of claim 7, wherein the service server issues at least one mobile card in response to a request from the mobile terminal and allows, when a new card is issued, the token service provider to store a token value of the new card and PAN information of the new card.

10. The method of claim 7, wherein the service server is connected to the mobile terminal through a service application operated in the mobile terminal, and the service application generates the request message using a token value of a mobile card selected in a tagging state of the mobile terminal and the physical card.

11. The method of claim 7, further comprising:
receiving a transaction request message from a payment terminal;
extracting PAN information corresponding to a token value of a card used for a transaction, which is included in the transaction request message; and
determining whether to approve the payment using the transaction detail information corresponding to the PAN information.

12. A system for managing a card transaction service, comprising:
a mobile terminal that stores at least one mobile card using a service application and transmits a setting request message to map the physical card to the mobile card; and
a service server that receives the request message from the mobile terminal and maps PAN information corresponding to a token value of the mobile card to a token value of the physical card to store the mapped PAN information, wherein the request message comprises the token value of the physical card and information on the mobile card mapped to the physical card.

13. The system of claim 12, wherein the service application generates the request message using the token value of the mobile card selected in a tagging state of the mobile terminal and the physical card.
